(19) United States
(12) Patent Application Publication
(10) Pub. No.: US 2026/0261283 A1
(43) Pub. Date: Sep. 3, 2026

(54) NEAR FIELD COMMUNICATION DEVICE AND METHOD FOR CONTROLLING A NEAR FIELD COMMUNICATION OF A NEAR FIELD COMMUNICATION DEVICE

(71) Applicant: BELIMO HOLDING AG, Hinwil (CH)

(72) Inventors: Pasquale WINTSCH, Hinwil (CH); Thomas POPP, Rapperswil-Jona (CH)

(73) Assignee: BELIMO HOLDING AG, Hinwil (CH)

(21) Appl. No.: 18/858,023

(22) PCT Filed: May 11, 2023
(86) PCT No.: PCT/EP2023/062541

§ 371 Date: Oct. 18, 2024

(30) Foreign Application Priority Data
May 13, 2022 (CH) CH000582/2022

(51) Int. Cl. H04B 5/48; H04B 5/77; H04B 5/79

(52) U.S. Cl. CPC H04B 5/48; H04B 5/77; H04B 5/79

(57) ABSTRACT

A near field communication device for communicating with a field device of a heating, ventilation and air conditioning system includes an electronic circuit that controls the near field communication device, and a near field communication circuit that is connected to the electronic circuit for near field communication with the field device. The electronic circuit controls the near field communication circuit to enable or disable the near field communication depending on one or more of information attributed to the field device or information attributed to the near field communication device.

### FIELD OF THE DISCLOSURE

The present disclosure relates to a near field communication device and a method for controlling a near field communication of a near field communication device. Specifically, the present disclosure relates to a near field communication device comprising a near field communication unit, a method for controlling a near field communication via a near field communication unit of a near field communication device and to a computer program product for controlling a near field communication via a near field communication unit of a near field communication device.

### BACKGROUND OF THE DISCLOSURE

A heating, ventilation and air conditioning system, in short HVAC System, is a system using various technologies to control the temperature, humidity, purity and/or further parameters in an enclosed space or at least a partially enclosed space. Conventional HVAC systems comprise for example, heating systems, cooling system and/or ventilation systems in order to control the above-mentioned parameters of the enclosed space. The enclosed space is, for example, a building or a particular area within the building.

In order to control and to adjust the above-mentioned parameters of the enclosed space, the HVAC System conventionally comprises at least one field device. The field device is, for example a sensor unit, an actuator unit, a valve unit, a damper unit or a combination of the aforementioned. The field device measures for example a temperature value, which is transferred to a central unit of the HVAC system for processing. The central unit may control, using the received temperature value, a particular valve unit (field device) of the HVAC System to increase or reduce a fluid flow, which increases or reduced the temperature in the enclosed space.

A particular important aspect of a HVAC System is to properly configure and to adjust the system, for example, at commissioning/starting of the HVAC system. Different parts of the HVAC system, like central units and/or field devices may have to be adjusted and configured. The initial and future configuration may be performed via a near field communication (NFC) interface between the central units/the field devices and a commissioning device. The commissioning device is for example a near field communication device, which is used by an operator to configure the specific field devices and/or additional parts of the HVAC system. Commissioning the HVAC system via available NFC interfaces is comparably simple because no wired connection between the specific device and the field device, which is to be commissioned, is required.

This relatively simple access possibility to the HVAC system provides also a relatively simple access point for third parties to the HVAC System. To avoid such an unintended access or a break into the HVAC system, the HVAC system may comprise barriers to avoid the unintended access by third parties. A conventionally used obstacle to accessing the HVAC system is to place the different parts/units of the HVAC system at restricted areas of the building, which require specific access permissions. Nevertheless, the HVAC system itself is in this scenario not protected by the unintended access by third parties. In particular, during a construction phase or a renovation phase of a building the restricted areas may not be closed for third parties at all times, which may give third parties access to the HVAC system. Further, the HVAC system or different parts of the HVAC system may be attacked during shipment or installation.

### SUMMARY OF THE DISCLOSURE

It is an object of this disclosure to provide a near field communication device and a method for controlling a near field communication of a near field communication device. In particular, it is an object of the present disclosure to provide a near field communication device and a method for controlling a near field communication of a near field communication device, which near field communication device and method do not have at least some of the disadvantages of the prior art.

According to the present disclosure, these objects are addressed by the features of the independent claims. In addition, further advantageous embodiments follow from the dependent claims and the description.

According to the present disclosure, a near field communication device for communicating with a field device of a heating, ventilation and air conditioning system is specified. The near field communication device comprises an electronic circuit configured to control the near field communication device. The near field communication device further comprises a near field communication unit connected/coupled to the electronic circuit, and being configured for a near field communication with the field device, wherein the electronic circuit is configured to control the near field communication unit to at least partially enable or at least partially disable the near field communication depending on information attributed to the field device and/or information attributed to the near field communication device.

In an embodiment, the electronic circuit is configured to receive power supply data attributed to the field device, and the electronic circuit is configured to control the near field communication unit to at least partially enable the near field communication in case the power supply data indicates that the field device is currently supplied with electrical energy, or at least partially disable the near field communication in case the power supply data indicates that the field device is currently not supplied with electrical energy.

In an embodiment, the near field communication device further comprises a position detecting unit, which is configured to determine a current geographical position attributed to the near field communication device, wherein the electronic circuit is configured to compare the determined current geographical position with a predefined geographical region and to control the near field communication unit to at least partially enable the near field communication in case the determined current geographical position is within the predefined geographical region, or to at least partially disable the near field communication in case the determined current geographical position is outside the predefined geographical region. In an embodiment, the position-detecting unit uses a satellite based radio-navigation system, also known generically as a global navigation satellite system (GNSS) like the global positioning system GPS, Galileo, GLONAS or BeiDou. In another embodiment, the position-detecting unit uses a Wi-Fi based positioning system, a cellular positioning system (CPS), e.g. the Global System for Mobile communication based position system (GSM), WCDMA, UMTS, LTE, etc. or a different kind of positioning system.

In an embodiment, the electronic circuit is configured to receive a current geographical position attributed to the field device, and wherein the electronic circuit is configured to compare the received current geographical position with a predefined geographical region and to control the near field communication unit to at least partially enable the near field communication in case the received current geographical position is within the predefined geographical region, or at least partially disable the near field communication in case the received current geographical position is outside the predefined geographical region.

In an embodiment, the electronic circuit is configured to retrieve the predefined geographical region from a memory unit of the near field communication device or from a remote server, or wherein the electronic circuit is configured to receive the predefined geographical region from the field device.

In a further embodiment, the predefined geographical region may be retrieved by the near field communication device in dependence of the specific field device. In an embodiment, the predefined geographical region is a predefined usage place of the field device. In other words, the predefined usage place may be the area of the building for which the field device is intended. The predefined geographical region is, in another embodiment, a continent, a country or an area within a country.

In an embodiment, the electronic circuit is configured to receive field device type data attributed to the field device, and wherein the electronic circuit is configured to compare the received field device type data with a predefined list of field device types and to control the near field communication unit to at least partially enable the near field communication in case the field device type positively matches with at least one of the predefined field device types listed, or to at least partially disable the near field communication in case the determined field device type does not match with at least one of the predefined field device types listed.

In an embodiment, the electronic circuit is configured to receive unique identification data information attributed to the field device, which uniquely identifies the field device, and wherein the electronic circuit is configured to control the near field communication unit to enable the near field communication in case permissions of the near field communication device positively match with the unique identification data, or to disable the near field communication in case the permissions of the near field communication device do not match with the unique identification data.

In an embodiment, the electronic circuit is configured to control a user interface of the near field communication device such that it displays information to an operator in case the received power supply data indicates that the field device is currently not supplied with electrical energy, wherein the displayed information comprise that the specific field device is currently not supplied with electrical energy and/or that it is necessary to supply the field device with electrical energy in order to enable the near field communication with the field device.

In an embodiment, the electronic circuit is configured to control the near field communication unit to at least partially enable or at least partially disable a transfer of data via the near field communication depending on information attributed to the field device and/or information attributed to the near field communication device. In other words, the near field communication is at least partially enabled, at least partially disabled for transfer of data.

In a further aspect of the present disclosure, a method of controlling a near field communication via a near field communication unit of a near field communication device with a field device of a heating, ventilation and air conditioning system is specified. The method comprises:
receiving, by an electronic circuit of the near field communication device, information attributed to the field device and/or retrieving, by the electronic circuit, information attributed to the near field communication device; and
controlling, by the electronic circuit, the near field communication unit connected/coupled to the electronic circuit, to at least partially enable or to at least partially disable the near field communication depending on the received information and/or the retrieved information.

In an embodiment, the information received comprises power supply data attributed to the field device indicating if the field device is currently supplied or not supplied with electrical energy, and wherein controlling comprises:
at least partially enabling, by the electronic circuit, the near field communication via the near field communication unit in case the received power supply data indicates that the field device is currently supplied with electrical energy; and/or
at least partially disabling, by the electronic circuit, the near field communication via the near field communication unit in case the received power supply data indicates that the field device is currently not supplied with electrical energy.

In an embodiment, the retrieved information attributed to the near field communication device comprises geographical position data indicating a current geographical position of the near field communication device. The method further comprises:
comparing, by the electronic circuit, the current geographical position with a predefined geographical region;
at least partially enabling, by the electronic circuit, the near field communication via the near field communication unit in case the current geographical position of the near field communication device is within the predefined geographical region; or
at least partially disabling, by the electronic circuit, the near field communication via the near field communication unit in case the current geographical position of the near field communication device is outside the predefined geographical region.

In an embodiment, the received information attributed to the field device comprises geographical position data indicating a current geographical position of the field device. The method further comprises:
comparing, by the electronic circuit, the current geographical position with a predefined geographical region;
at least partially enabling, by the electronic circuit, the near field communication via the near field communication unit in case the current geographical position is within a predefined geographical region; or
at least partially disabling, by the electronic circuit, the near field communication via the near field communication unit in case the current geographical position is outside the predefined geographical region.

In an embodiment, the method further comprises retrieving, by the electronic circuit, the predefined geographical region from a memory unit of the near field communication device or a remote server, or receiving, by the electronic circuit, the predefined geographical region from the field device.

In an embodiment, the information received, by the electronic circuit, from the field device comprises field device type data attributed to the field device. The method further comprises:
comparing, by the electronic circuit, the field device type data with a predefined list of field device types; and
at least partially enable, by the electronic circuit, the near field communication via the near field communication unit in case the field device type data positively matches with at least one of the predefined field device types listed; or
at least partially disable, by the electronic circuit, the near field communication via the near field communication unit in case the field device type data does not match with at least one of the predefined field device types listed.

In an embodiment, the information received, by the electronic circuit, from the field device comprises unique identification data attributed to the field device, which is configured to uniquely identify the field device. Wherein controlling comprises:
at least partially enable, by the electronic circuit, the near field communication via the near field communication unit in case permissions of the near field communication device positively match with the unique identification data, and/or
at least partially disable, by the electronic circuit, the near field communication via the near field communication unit in case the permissions of the near field communication device do not match with the unique identification data.

In an embodiment, the method further comprises:
providing, by the electronic circuit, a code and transmitting, via the near field communication unit, the code to the field device;
receiving, by the electronic circuit, information of a verification of the code from the field device;
at least partially disable, by the electronic circuit, the near field communication via the near field communication unit in case the verification information indicates a failed verification; or
at least partially enable, by the electronic circuit, the near field communication via the near field communication unit in case the verification information indicates a successful verification.

In an embodiment, the method further comprises:
controlling, by the electronic circuit, a user interface of the near field communication device such that it displays information to an operator in case the received power supply data indicate that the field device is currently not supplied with electrical energy, wherein the displayed information comprise that the specific field device is currently not supplied with electrical energy and/or that it is necessary to supply the field device with electrical energy in order to enable the near field communication with the field device.

In a further aspect of the present disclosure, a computer program product is specified comprising computer program code configured to direct a near field communication device or an application running on the near field communication device such that the near field communication device or the application performs the steps according to a method as described above and hereinafter.

In a further aspect of the present disclosure, a computer-readable medium, in particular a non-transitory computer-readable medium, is specified having stored therein computer program code configured to direct a near field communication device or an application running on the near field communication device such that the near field communication device or the application performs the steps according to a method as described above and hereinafter.

### BRIEF DESCRIPTION OF THE DRAWINGS

The present disclosure will be explained in more detail, by way of example, with reference to the drawings in which:

FIG. 1: shows a first block diagram illustrating schematically a HVAC system comprising a field device,

FIG. 2: shows a second block diagram illustrating schematically the HVAC system of FIG. 1, wherein the field device and a near field communication device is shown in detail,

FIG. 3: shows a first flow diagram illustrating a first sequence of steps for controlling a near field communication of a near field communication device,

FIG. 4: shows a second flow diagram illustrating a second sequence of steps for controlling a near field communication of a near field communication device,

FIG. 5: shows a third flow diagram illustrating a detail of the step “controlling the near field communication” for controlling a near field communication of a near field communication device,

FIG. 6: shows a fourth flow diagram illustrating a third sequence of steps for controlling a near field communication of a near field communication device,

FIG. 7: shows a fifth flow diagram illustrating a fourth sequence of steps for controlling a near field communication of a near field communication device,

FIG. 8: shows a sixth flow diagram illustrating a fifth sequence of steps for controlling a near field communication of a near field communication device,

FIG. 9: shows a seventh flow diagram illustrating a sixth sequence of steps for controlling a near field communication of a near field communication device,

FIG. 10: shows an eighth flow diagram illustrating a seventh sequence of steps for controlling a near field communication of a near field communication device,

FIG. 11: shows a ninth flow diagram illustrating an eighth sequence of steps for controlling a near field communication of a near field communication device.

### DETAILED DESCRIPTION OF THE EMBODIMENTS

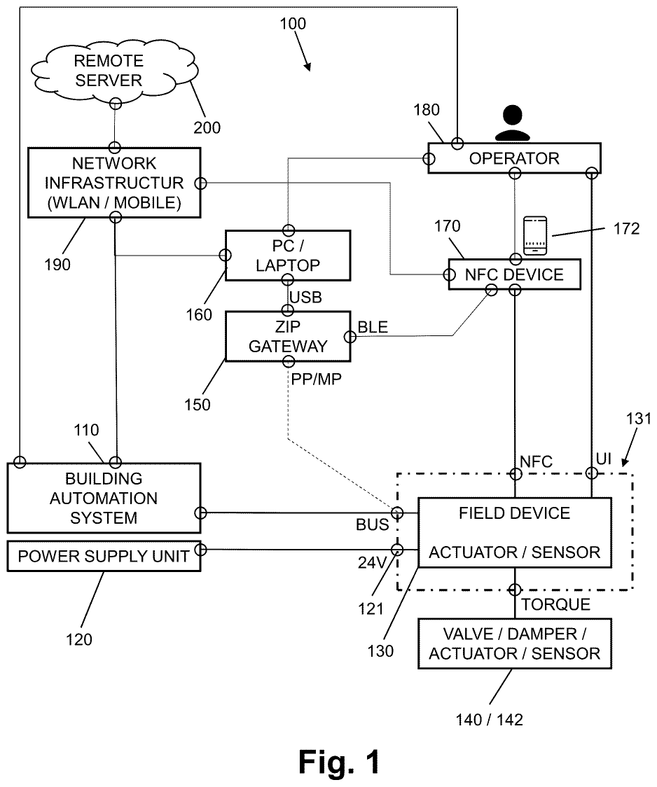

FIG. 1 (abbr.: FIG. 1, as used in the drawings) shows schematically a block diagram illustrating schematically a HVAC system 100. The HVAC system 100 comprises a field device 130, which is configured to control a valve/damper/actuator 140 to control, for example, a flow of fluid of the HVAC system 100. In this embodiment, the field device 130 transmits for example torque via a shaft to the valve/damper 140, in this embodiment, the field device 130 forms for example an actuator unit. In another embodiment, the field device 130 is connected to a sensor 142 and is configured to receive and process sensor measurement data. A combination of e.g. a sensor 142 and an actuator 140 is also conceivable, such that the field device 130 may control the actuator, which controls a valve and that the field device 130 may receive data from the sensor 142. In a further embodiment, the field device 130 may transmit control data to an actuator 140, e.g. located outside of the field device 130, which produces the torque accordingly to control an actuated part, e.g. a valve 140 or a damper 140. FIG. 1 further shows schematically that the field device 130 is connected via a bus interface to a building automation system (BAS) 110. Further, other devices of the HVAC system 100 are, for example, also connected to the building automation system 110. The field device 130 is according to the present disclosure of FIG. 1 supplied with electrical energy via a power supply unit 120. The power supply unit 120 is, for example, an electrical network of a building, a battery system and/or a combination of the aforementioned. The power supply unit 120 provides electrical energy to the field device 130 via a power supply terminal 121 with a voltage for example from 12 Volt to 240 Volt, preferred 24 Volt or 230 Volt.

FIG. 1 further shows access possibilities for accessing/contacting the field device 130 by an operator 180. The operator 180 may control a PC/Laptop 160, which is connected via a universal serial bus (USB) connection to a Gateway 150, which is connected via the BUS system to the field device 130. The field device 130 is according to this embodiment accessible via the PC/Laptop 160 for configuring, commissioning or adapting settings of the field device 130 or to read data from the field device 130. The PC/Laptop 160 is connected via a network infrastructure 190 to a remote server 200. The network infrastructure 190 uses, for example, a mobile data network, such as Global System for mobile Communication (GSM), Code Division Multiple Access (CDMA), or Long Term Evolution (LTE) networks, and/or a close range wireless communication interface using Wi-Fi, Bluetooth®, and/or other wireless area network (WLAN) types and standards. The remote server 200 is configured to store data, which is used by the PC/Laptop 160, and/or different devices.

FIG. 1 further shows a near field communication device 170 (NFC device) which may be operated by the operator 180. The near field communication device 170 is, for example, a mobile device 172, e.g. a smartphone, tablet, laptop or other portable electronic device with NFC capability. The near field communication device 170 is configured to contact or access (read/write) the field device 130 via a near field communication (NFC) interface. Near field communication is a communication protocol, which enables communication, transfer of data, between two electronic devices over a distance of, for example, 100 mm or less. The near field communication device 170 is, according to this embodiment, also connected to the remote server 200 via the network infrastructure 190. In addition, the near field communication device 170 may also be connected to the gateway 150 via a Bluetooth low energy (BLE) interface.

FIG. 1 further shows that the field device 130 comprises a user interface (UI), which may be used by the operator 180 to adjust/configure the field device 130 directly. The configuration possibilities, which are accessible via the user interface of the field device 130 are, for example, limited. FIG. 1 further shows that the near field communication device 170 is connected via the network infrastructure 190, for example the mobile network or a wireless LAN network, to the remote server 200.

FIG. 1 further show that the building automation system (BAS) 110 may also be connected via the network infrastructure 190 to the remote server 200, which enables e.g. remote access to the building automation system 110. Further, the figures show that the operator 180 may access the building automation system 110 directly, for example via an onsite access terminal or indirectly, via the mobile device 172 and the respective network infrastructure 190 or via the PC/Laptop 160 and the respective network infrastructure 190. The connection between the field device 130 and the near field communication device 170 via the building automation system 110 and the network infrastructure 190 may in addition or alternatively to the direct nfc connection between the near field communication device 170 and the field device 130 be used for data transfer between these devices.

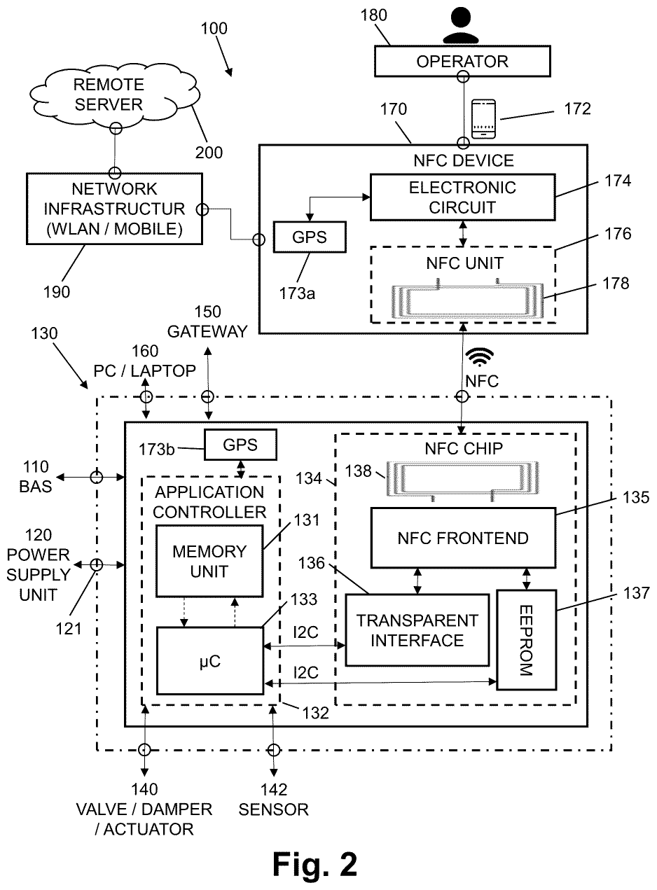

FIG. 2 shows schematically a block diagram illustrating the HVAC system 100 of FIG. 1 in more detail. In particular, the field device 130, the access possibilities to the field device 130, the near field communication device 170 and the connection possibilities of the near field communication device 170 are illustrated in a more detailed manner.

FIG. 2 shows the field device 130 comprising an application controller 132 and a near field communication chip 134. The application controller 132 is configured to control the valve / damper 140 and is configured to receive data from the sensor 142. The application controller 132 comprises a microcontroller 133 and a memory unit 131. The microcontroller 133 is configured to control the application controller 132 and in particular the valve/damper/actuator 140 and to process data received from the sensor 142. The memory unit 131 is configured to store and provide data for the microcontroller 133. The near field communication chip 134 comprises a near field communication front-end 135, a transparent interface 136, an electrically erasable programmable read-only memory 137 (EEPROM) and an antenna 138. The transparent interface 136 allows the connection and operation between the microcontroller 133 and the near field communication chip 134 without modifications. The microcontroller 133 of the application controller 132 is configured to communicate with the transparent interface 136 and the EEPROM 137 of the near field communication chip 134. The communication between the microcontroller 133 and the transparent interface 136 is, according to this embodiment, performed via a serial communication bus, like inter-integrated circuit (12C). The transparent interface 136 and the EEPROM 137 are configured to communicate with the NFC front-end 135. The NFC front-end 135 comprises the antenna 138 or the NFC front-end 135 is connected to the antenna 138, which is configured to transmit and to receive data. The EEPROM 137 can be accessed via the external near field communication device 170, even if the field device 130 is not supplied with electrical energy via the power supply terminal 121. In other words, the near field communication device 170 can retrieve data from the EEPROM 137 even if the field device 130 is not supplied with electrical energy via the power supply terminal 121. In case the field device 130 is supplied with electrical energy via the power supply terminal 121, the near field communication device 170 may communicate with the EEPROM 137 or the application controller 132 of the field device 130.

FIG. 2 further shows the near field communication device 170 comprising an electronic circuit 174, which is configured to control the near field communication device 170. The near field communication device 170 further comprises a near field communication (NFC) unit 176 comprising a near field communication device antenna 178. The near field communication unit 176 is connected to the electronic circuit 174 and is configured for a near field communication with the field device 130. The electronic circuit 174 is configured to control the near field communication unit 176. FIG. 2 further shows a position-detecting unit 173a within the near field communication device 170. The position-detecting unit 173a is configured to determine a current geographical position of the field device 170. The electronic circuit 174 is configured to control the position-detecting unit 173a and to retrieve or to receive from the position-detecting unit 173a the current geographical position of the near field communication device 170. The position-detecting unit 173a uses, for example, a satellite-based radio navigation system, also known as a global navigation satellite system (GNSS) like GPS to determine the geographical position. In another embodiment, the geographical position unit 173a uses a Wi-Fi based positioning system, a global system for mobile communication based position system, a cellular positioning system (CPS), e.g. GSM, CDMA, UMTS, LTE, etc. or different kind of technologies to determine the current geographical position. FIG. 2 further shows that the field device 130 may comprise also a position-detecting unit 173b, which is connected to the application controller 132 and which is configured to determine a current geographical position of the field device 130. It is also conceivable that the position-detecting unit 173a is integrated in the electronic circuit 174 of the near field communication device 170 or that the position-detecting unit 173b is integrated in the application controller 132, in particular in the microcontroller 133 of the field device 130.

In an embodiment, the field device 130 comprises a power monitoring system (not shown in the Figures), which is configured to monitor the power supply terminal 121, and wherein the power monitoring system is configured to transmit current or present power supply data to the microcontroller 132 and/or to the EEPROM 137. In an embodiment, the power monitoring system monitors the current flow or a different electric property to determine the power supply data.

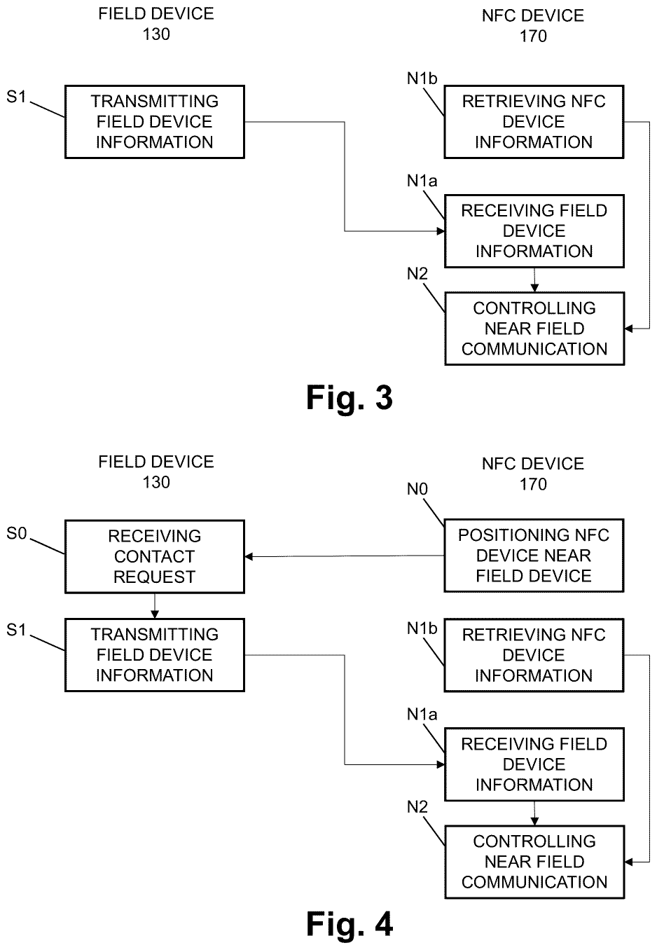

FIG. 3 shows a first flow diagram illustrating a first sequence of steps for controlling a near field communication of the near field communication device 170. In the following paragraphs, described with reference to FIG. 3 is a possible sequence of steps, performed by the electronic circuit 174 for controlling the near field communication of the near field communication device 170.

In step S1, the field device 130 transmits information attributing the field device 130 or relating to the field device 130 to the near field communication device 170. The information is transmitted via an established NFC connection between the near field communication device 170 and the field device 130. The information may be transmitted from the microcontroller 133, the EEPROM 137 or a different part of the field device 130.

In step N1a, the electronic circuit 174 of the near field communication device 170, receives the information attributed to the field device 130. Information attributing the field device 130 is for example information/data from or of the field device 130.

In step N1b, the electronic circuit 174 of the near field communication device 170, retrieves information attributing the near field communication device 170. Information attributing the near field communication device 170 is for example information/data from or of the near field communication device 170.

In step N2, the electronic circuit 174, controls the near field communication unit 176 to at least partially enable or at least partially disable the near field communication using the received information attributed to the field device 130 and/or the retrieved information attributed to the near field communication device 170. The near field communication may comprise transfer of data. At least partially enabling or at least partially disabling comprises to at least partially enable or at least partially disable the transfer of data. Partially enabling of the near field communication is for example, to enable reading or writing of specific configuration data, settings and/or operational/diagnostic data. Partially disabling of the near field communication is, for example, to disable reading or writing of specific configuration data, settings and/or operational/diagnostic data. The configuration data may include motor speed, closing time, closing torque, opening time, opening torque of the valve/damper 140 and/or other devices settings. The configuration data may further include parameters of auxiliary switches, which open/close, for example, as a function of the valve/damper 140 position. Settings and/or operational/diagnostic data may further include configuration parameters such as a target value of flow rate, a set value of altitude for adjusting the measurement of a flow sensor. The operation-related data includes values such as number of cycles, number of movements, maximum travel angle, minimum travel angle, etc., measurement values provided by the sensor 142 etc. All or at least a combination of these values/data may be subject of at least partially enabling of reading/writing via the near field communication. Further, all or at least a combination of these values/data may be subject of at least partially disabling of reading/writing via the near field communication.

In a preferred embodiment, fully enabling of the near field communication is, for example, to fully enable reading or writing, without limitations. Partially disabling of the near field communication is for example, to disable reading or writing of specific predefined configurations, settings and/or operational/diagnostic data, as described above. In a preferred embodiment, fully disabling of the near field communication is, for example, to fully disable reading or writing, without limitations. Fully disabling may comprise to fully terminate the near field communication of the near field communication device 170.

According to the present disclosure, it is possible to control the near field communication via the near field communication unit 176 of the near field communication device 170 itself in dependence of information/data of the near field communication device 170 and/or in dependence of information/data of the field device 130. It is therefore possible to control the near field communication and to limit or restrict unintended third-party access.

In an embodiment, this method and/or the method described above and hereinafter is/are executed immediately after the near field connection between the field device 130 and the near field communication device 170 is established to determine if the specific near field communication device has permissions to read/write the field device 130. In case the near field communication device 170 can read or write to the specific field device 130, based on the information attributed to the field device 130 and/or attributed to the near field communication device 170, the near field communication is at least partially enabled. Otherwise, the near field communication is at least partially disabled/terminated.

In an embodiment, this method and/or the method described above and hereinafter is/are executed preferably if a user program/application for configuring the field device 130 has been started on the near field communication device 170. The start of the program/application may also be initiated automatically, triggered by the established near field connection between the field device 130 and the near field communication device 170.

FIG. 4 shows a second flow diagram illustrating a second sequence of steps for controlling a near field communication of the near field communication device. In the following paragraphs, described with reference to FIG. 4 is a possible sequence of steps, performed by the electronic circuit 174 for controlling the near field communication of the near field communication device 170.

In step N0, the near field communication device 170 is positioned near the field device 130 such that the NFC connection may be established. In another embodiment, the field device 130 may be positioned near the near field communication device 170.

In step S0, the field device 130, in particular the near field communication chip 134 receives a connection request from the near field communication device 170 via for example the established NFC connection. In this embodiment, the steps N0 and S0 are preparatory steps. Based on the received contact request, the field device 130 transmits in step S1 information attributed to the field device 130 to the near field communication device 170. The steps S1, N1b, N1a and N2 of FIG. 4 do not differ from the same annotated steps of FIG. 3 and thus will not be repeated.

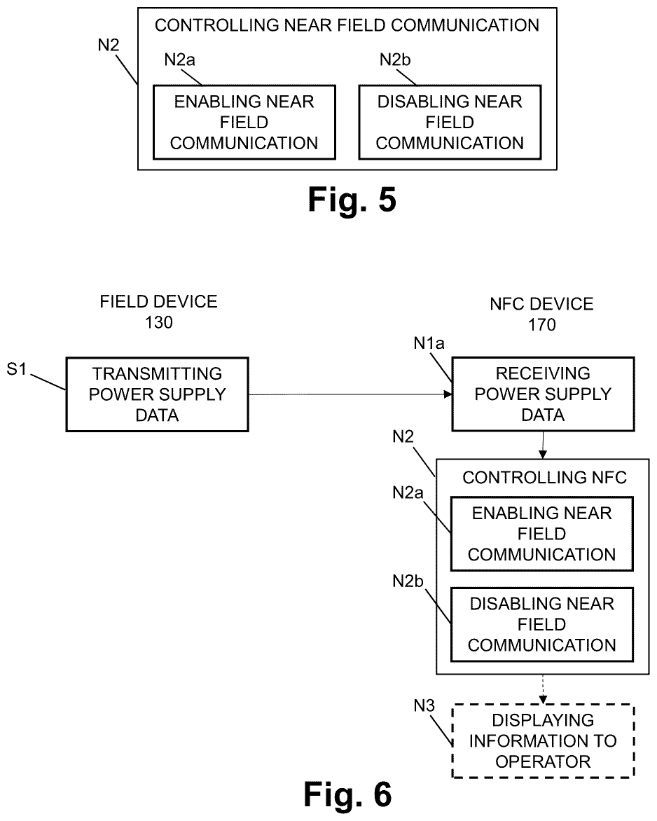

FIG. 5 shows a third flow diagram illustrating a detail of the step of “controlling the near field communication (NFC)” as shown in the FIGS. 3 and 4 for controlling a near field communication of a near field communication device 170. In the following paragraphs, described with reference to FIG. 5 is a detail of the step N2 “controlling the near field communication”, performed by the electronic circuit 174 for controlling the near field communication of the near field communication device 170.

The step N2, the electronic circuit 174, controls the near field communication unit 176 to at least partially enable or at least partially disable the near field communication. Both options are shown in FIG. 5.

In step N2a, the electronic circuit 174, at least partially enables the near field communication depending on the received information attributed to the field device 130 and/or depending on the retrieved information attributed to the near field communication device 170.

In the alternative step N2b, the electronic circuit 174, at least partially disables the near field communication using the received information attributed to the field device 130 and/or using the retrieved information attributed to the near field communication device 170.

FIG. 6 shows a fourth flow diagram illustrating a third sequence of steps for controlling a near field communication of a near field communication device. In the following paragraphs, described with reference to FIG. 6 is a possible sequence of steps, performed by the electronic circuit 174 of the near field communication device 170 and the field device 130 for controlling the near field communication of the near field communication device 170.

In step S1, the field device 130 transmits power supply data attributed to the field device 130 to the near field communication device 170 via, for example the established NFC connection or the building automation system 110. The power supply data indicates if the field device 130 is currently supplied or not supplied with electrical energy via the power supply terminal 121. In an embodiment, the power supply data is stored in the EEPROM 137 in case the field device 130 is not supplied with electrical energy via the power supply terminal 121. The power monitoring system may be used to determine the power supply via the power supply terminal 121. In case the power monitoring system determines a drop of power supply (or a drop in voltage), it transmits this information using, for example energy from an energy buffer, to the EEPROM 137 or to another memory unit of the near field communication chip 134, which stores this information. In case the near field communication device 170 accesses the field device 130, the power supply data stored in the EEPROM 137 or in the other memory unit is transmitted to the near field communication device 170. The energy buffer may be provided via the near field communication device 170. In another embodiment, the power supply data is determined by the near field communication chip 134 by contacting the microcontroller 133. For example, in case the microcontroller 133 does not respond, a missing electrical energy supply is determined and transmitted.

In step N1a, the near field communication device 170, in particular the electronic circuit 174 receives the power supply data transmitted from the field device 130. The power supply data is processed by the electronic circuit 174 and the electronic circuit 174 controls in step N2 the near field communication unit 176 accordingly.

In step N2a, the electronic circuit 174 controls the near field communication unit 176 such that the near field communication is at least partially enabled in case the power supply data indicates that the field device 130 is currently supplied with electrical energy. In other words, the near field communication is only enabled in case the field device 130 is supplied with electrical energy, for example during its normal operation.

In step N2b, the electronic circuit 174 controls the near field communication unit 176 such that the near field communication is at least partially disabled in case the power supply data indicates that the field device 130 is currently not supplied with electrical energy. In other words, the near field communication is disabled in case the field device 130 is not supplied with electrical energy, for example during shipment. In another embodiment, no response from the field device 130 to a request from the near field communication device 170 is considered/interpreted by the near field communication device 170 such that the field device 130 is currently not supplied with electrical energy.

According to this embodiment, it is possible to control the near field communication of the near field communication device 170 using power supply information/data of the field device 130, which advantageously creates the possibility to avoid unintended third-party access for example during timespans where the field device 130 is not provided with electrical energy.

In an optional step N3, the electronic circuit 174 controls a user interface of the near field communication device 170 such that it displays information to the operator 180. The displayed information may comprise a notice that the specific field device 130 is currently not supplied with electrical energy and that it is necessary to supply the field device 130 with electrical energy in order to enable the near field communication with the field device 130.

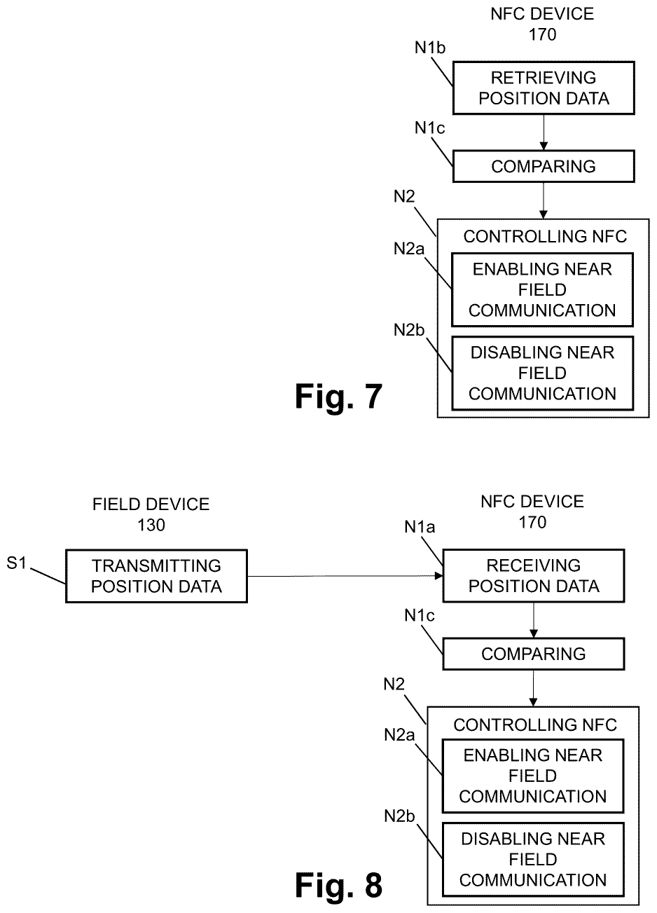

FIG. 7 shows a fifth flow diagram illustrating a fourth sequence of steps for controlling a near field communication of the near field communication device 170. In the following paragraphs, described with reference to FIG. 7 is a possible sequence of steps, performed by the electronic circuit 174 of the near field communication device 170 for controlling the near field communication of the near field communication device 170.

In step N1b, the electronic circuit 174 of the near field communication device 170 retrieves information attributed to the near field communication device 170 comprising geographical position data. The geographical position data indicates a current geographical position of the near field communication device 170. The electronic circuit 174 may retrieve the geographical position data from the position-detecting unit 173a.

In step N1c, the electronic circuit 174 compares the retrieved current geographical position of the near field communication device 170 with a predefined geographical region. In an embodiment, the predefined geographical region is a predefined usage place of the field device 130. In other words, the predefined usage place may be the area of the building for which the field device 130 is intended to be used. The predefined geographical region is, in another embodiment, a continent, a country or an area within a country. The predefined geographical region is, for example, stored in the near field communication device 170 or retrieved from the remote server 200. In an embodiment, the predefined geographical region is received from the field device 130 or selected in dependence of the specific field device 130. Different field devices 130 or each field device 130 may have their predefined usage place, which determines the predefined geographical region. Based on the result of the comparison in step N1c is the near field communication unit 176 controlled in step N2 by the electronic circuit 174.

In step N2a, the electronic circuit 174 controls the near field communication unit 176 such that the near field communication is at least partially enabled in case the current geographical position of the near field communication device 170 is within the predefined geographical region. In other words, the near field communication is only enabled in case the near field communication device 170 is located within the predefined geographical region, for example a specific country or a specific building or plant.

In step N2b, the electronic circuit 174 controls the near field communication unit 176 such that the near field communication is at least partially disabled in in case the current geographical position of the near field communication device 170 is outside the predefined geographical region. In other words, the near field communication is disabled in case the near field communication device 170 is located outside the predefined geographical region, for example during shipment.

According to this embodiment, it is possible to control the near field communication of the near field communication device 170 based on the current geographical position of the near field communication device 170, which advantageously creates the possibility to avoid unintended third-party access for example during timespans, in which the field device 130 is not within the predefined geographical region, for example during shipment.

FIG. 8 shows a sixth flow diagram illustrating a fifth sequence of steps for controlling a near field communication of a near field communication device 170. In the following paragraphs, described with reference to FIG. 8 is a possible sequence of steps, performed by the electronic circuit 174 of the near field communication device 170 and the field device 130 for controlling the near field communication of the near field communication device 170.

In step S1, the field device 130 transmits geographical position data attributed to the field device 130 to the near field communication device 170, for example via the established NFC connection. The geographical position data indicates the current geographical position of the field device 130. In an embodiment, the geographical position data is stored in the EEPROM 137 in case the field device 130 is not supplied with electrical energy via the power supply terminal 121. The position-detecting unit 173b of the field device 130 may be used to determine the geographical position data. In case the near field communication device 170 accesses the field device 130, the geographical position data stored in the EEPROM 137 is transmitted to the near field communication device 170.

In step N1a, the near field communication device 170, in particular the electronic circuit 174 receives the geographical position data transmitted from the field device 130. The geographical position data is processed by the electronic circuit 174 to determine the current geographical position of the field device 130 and the electronic circuit 174 controls in step N2 the near field communication unit 176 using the current geographical position of the field device 130.

In step N1c, the electronic circuit 174 compares the received current geographical position of the field device 130 with the predefined geographical region, similarly as described above with respect to FIG. 7 with the difference that the current geographical position is received from the field device 130 and not retrieved from the near field communication device 170. Based on the result of the comparison in step N1c is the near field communication unit 176 controlled in step N2 by the electronic circuit 174.

In step N2a, the electronic circuit 174 controls the near field communication unit 176 such that the near field communication is at least partially enabled in case the current geographical position of the field device 130 is within the predefined geographical region.

In step N2b, the electronic circuit 174 controls the near field communication unit 176 such that the near field communication is at least partially disabled in in case the current geographical position of the field device 130 is outside the predefined geographical region.

According to this embodiment, it is possible to control the near field communication of the near field communication device 170 based on the current geographical position of the field device 130, which advantageously creates the possibility to avoid unintended third-party access for example during timespans, in which the field device 130 is not within the predefined geographical region, for example during shipment. A combination of the method as described with reference to FIG. 7 and of the method as described with reference to FIG. 8 is also conceivable.

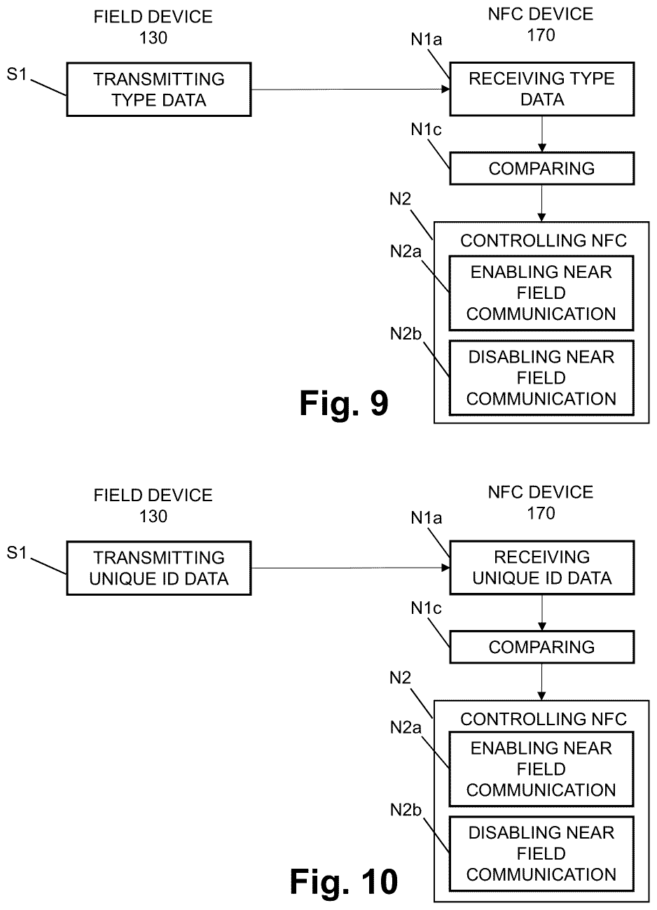

FIG. 9 shows a seventh flow diagram illustrating a sixth sequence of steps for controlling a near field communication of a near field communication device 170. In the following paragraphs, described with reference to FIG. 9 is a possible sequence of steps, performed by the electronic circuit 174 of the near field communication device 170 and the field device 130 for controlling the near field communication of the near field communication device 170.

In step S1, the field device 130 transmits field device-type data attributed to the field device 130 to the near field communication device 170 via, for example the established NFC connection. The field device-type data indicates the type of the field device 130, like a specific sensor unit, an actuator unit, a valve unit or other types of field devices 130. In an embodiment, the field device-type data is stored in the EEPROM 137 in case the field device 130 is not supplied with electrical energy via the power supply terminal 121. The field device-type data may also be stored in the memory unit 131. In case the near field communication device 170 accesses the field device 130, the field device-type data stored in the EEPROM 137 is transmitted to the near field communication device 170.

In step N1a, the near field communication device 170, in particular the electronic circuit 174 receives the field device-type data transmitted from the field device 130. The field device-type data is processed by the electronic circuit 174 to determine the field device-type of the specific field device 130 with which the near field communication device 170 is connected. The electronic circuit 174 of the near field communication device 170 controls in step N2 the near field communication unit 176 using the field device-type data of the field device 130.

In step N1c, the electronic circuit 174 compares the field device-type data with a predefined list of field device types. Based on the result of the comparison in step N1c is the near field communication unit 176 controlled in step N2 by the electronic circuit 174. The predefined list of field device types is, for example, stored in the near field communication device 170. For example, an operator 180 has permissions to access and configure a specific type of sensor and a specific type of actuator as field devices 130. The predefined list would, for this specific operator (for the specific near field communication device 170) consist of the specific sensor type and the specific actuator type. The received field device type-data is compared to this list, e.g. to determine whether the received field device type-data is contained in the list, and the near field communication unit 176 is controlled in step N2 according to the result of the comparison.

In step N2a, the electronic circuit 174 controls the near field communication unit 176 such that the near field communication is at least partially enabled in case the field device type-data positively matches with at least one of the predefined field device types listed.

In step N2b, the electronic circuit 174 controls the near field communication unit 176 such that the near field communication is at least partially disabled in case the field device type-data does not match with at least one of the predefined field device types listed.

In other words, the near field communication is only enabled if the operator or the near field communication device 170 has the required permissions for this specific field device type. The predefined list is for example stored and managed on the remote server 200.

FIG. 10 shows an eighth flow diagram illustrating a seventh sequence of steps for controlling a near field communication of a near field communication device 170. In the following paragraphs, described with reference to FIG. 10 is a possible sequence of steps, performed by the electronic circuit 174 of the near field communication device 170 and the field device 130 for controlling the near field communication of the near field communication device 170.

In step S1, the field device 130 transmits unique identification data attributed to the field device 130 to the near field communication device 170 via, for example the established NFC connection. The unique identification data uniquely identifies the specific field device 130, like a unique identification number for each field device 130 or a serial number. In an embodiment, the unique identification data is stored in the EEPROM 137 in case the field device 130 is not supplied with electrical energy via the power supply terminal 121. In case the near field communication device 170 accesses the field device 130, the field device-type data stored in the EEPROM 137 is transmitted to the near field communication device 170. The unique identification data may also be stored in the memory unit 131.

In step N1a, the near field communication device 170, in particular the electronic circuit 174 receives the unique identification data transmitted from the field device 130. The unique identification data is processed by the electronic circuit 174 to determine the unique field device 130 with which the near field communication device 170 is connected. The electronic circuit 174 of the near field communication device 170 controls in step N2 the near field communication unit 176 using the unique identification data of the field device 130.

In step N1c, the electronic circuit 174 compares the received unique identification data with permissions, stored for example in the near field communication device 170. Based on the result of the comparison in step N1c is the near field communication unit 176 controlled in step N2 by the electronic circuit 174. The comparison of the unique identification data with the permissions may comprise a request to the operator 180 to enter a password or another key. Based on the outcome of the comparison of the unique identification data with the permissions is the near field communication in step N2 controlled.

In step N2a, the electronic circuit 174 controls the near field communication unit 176 such that the near field communication is at least partially enabled in case the permissions of the near field communication device 170 positively match with the unique identification data.

In step N2b, the electronic circuit 174 controls the near field communication unit 176 such that the near field communication is at least partially disabled in case the permissions of the near field communication device 170 do not match with the unique identification data.

In other words, the operator 180 needs to have specific permissions, like the password, for the specific field device 130 to access and configure (read/write) the specific field device 130. The permissions may be managed in the remote server 200 and the near field communication device 170 may retrieve the permissions from the remote server 200.

In an embodiment, the near field communication device 170 requires the operator 180 to enter a password via the user interface of the near field communication device 170 in order to at least partially enable the near field communication. The password request is, for example, received by the electronic circuit 174 from the specific field device 130 after the NFC connection is established. In case the operator does not have the right password, the NFC connection is terminated by the electronic circuit 174.

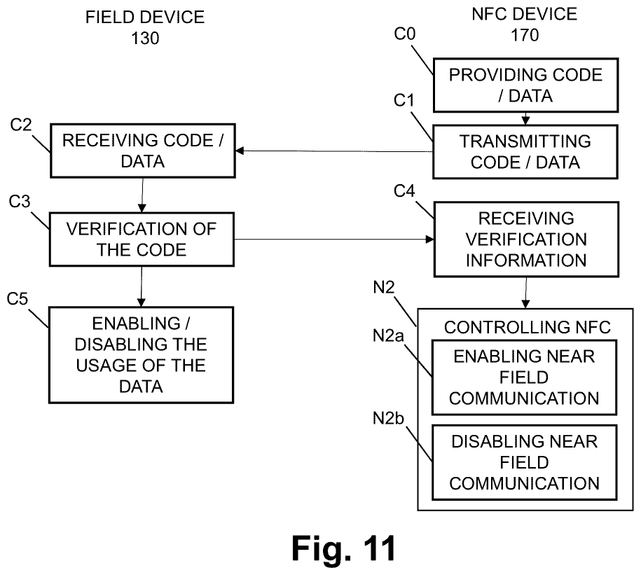

FIG. 11 shows a ninth flow diagram illustrating an eighth sequence of steps for controlling a near field communication of a near field communication device 170. In the following paragraphs, described with reference to FIG. 11 is a possible sequence of steps, performed by the electronic circuit 174 of the near field communication device 170 and the field device 130 for controlling the near field communication of the near field communication device 170.

In step C0, the electronic circuit 174 provides or creates a code, for example a bit sequence. The code is, for example, attached to a predefined data, which is planned to be transmitted.

In step C1, the electronic circuit 174 transmits the code via the established NFC connection from the near field communication device 170 to the field device 130 via the near field communication unit 176. In an embodiment, the code is transmitted attached to the predefined data to the field device 130.

In step C2, the field device 130 receives the code. In an embodiment, the code is received by the field device 130 in combination with the data.

In step C3, the field device 130, for example the microcontroller 133 of the field device 130, performs a verification of the received code. The result or the outcome of the verification is transmitted back to the near field communication device 170 via the established NFC connection. In an embodiment, the field device 130 performs a cyclic redundancy check (CRC), by calculating the checksum. In this case, the code is the CRC value.

In step C4, the near field communication device 170, in particular the electronic circuit 174, receives the verification information. Based on the result of the verification transmitted to the near field communication device 170 is the near field communication in step N2 controlled by the electronic circuit 174. In step N2a, the electronic circuit 174 controls the near field communication unit 176 such that the near field communication is at least partially enabled in case the verification information indicates a successful verification.

In step N2b, the electronic circuit 174 controls the near field communication unit 176 such that the near field communication is at least partially disabled in case in case the verification information indicates a failed verification.

In step C5, the field device 130, enables or disables the usage of the received data, within the field device 130, based on the result of the verification, e.g. CRC check of step C3. In case the CRC check determines an error within the received data, the usage of this data is disabled and the field device 130 may take corrective action, such as rereading the block or requesting resending of the data. In an embodiment, in case the CRC check determines an error within the received data, the field device 130 uses default/predefined data/settings instead of the corrupt received data. In case the CRC check determines no error within the received data, the usage of this data is enabled. This embodiment creates the advantage that corrupt data is discovered and not used by the field device 130. Such data may be corrupted by third parties or via errors in the data transmission.

According to this embodiment, is the near field communication of the near field communication device 170 only enabled if the code verification on the field device 130 was successful, otherwise, the near field communication of the near field communication device 170 is disabled and, for example terminated. Different verification methods are also conceivable.

It should be noted that, in the description, the sequence of the steps has been presented in a specific order, one skilled in the art will understand, however, that the order of at least some of the steps could be altered, without deviating from the scope of the disclosure.

### LIST OF REFERENCE SIGNS

100 HVAC System
110 Building automation system
120 Power supply unit
121 power supply
130 Field device
132 Application controller
133 Microcontroller
134 NFC chip
135 NFC frontend
136 Transparent interface
137 EEPROM
138 Field device antenna
140 Valve/Damper
142 Sensor
150 ZIP gateway
160 PC/Laptop
170 NFC device
172 Mobile device
173a Position detecting unit of NFC device
173b Position detecting unit of field device
174 Electronic circuit
176 Near field communication unit of the NFC device
178 NFC device antenna
180 Operator
190 Network Infrastructure
200 Remote server
S0 Receiving contact request
S1 Transmitting field device information
N0 Positioning NFC Device near field device
N1a Receiving field device information
N1b Retrieving NFC Device information
N1c Comparing
N2 Controlling near field communication
N2a Enabling near field communication
N2b Disabling near field communication
N3 Displaying information to operator
C0 Providing code
C1 Transmitting code
C2 Receiving code
C3 Verifying code
C4 Receiving verification information

1. A near field communication device for communicating with a field device of a heating, ventilation and air conditioning system the near field communication device comprising:
an electronic circuit configured to control the near field communication device;
a near field communication unit connected to the electronic circuit, and being configured for a near field communication with the field device;
wherein the electronic circuit is configured to control the near field communication unit to at least partially enable or at least partially disable the near field communication depending on at least one of: information attributed to the field device or information attributed to the near field communication device.

2. The near field communication device according to claim 1, wherein the electronic circuit is configured to receive power supply information attributed to the field device, and wherein the electronic circuit is configured to control the near field communication unit to at least partially enable the near field communication in case the power supply information indicates that the field device is currently supplied with electrical energy, or at least partially disable the near field communication in case the power supply information indicates that the field device is currently not supplied with electrical energy.

3. The near field communication device according to claim 1, further comprising a position detecting unit, which is configured to determine a current geographical position attributed to the near field communication device,
wherein the electronic circuit is configured to compare the determined current geographical position with a predefined geographical region and to control the near field communication unit to at least partially enable the near field communication in case the determined current geographical position is within the predefined geographical region, or to at least partially disable the near field communication in case the determined current geographical position is outside the predefined geographical region.

4. The near field communication device according to claim 1, wherein the electronic circuit is configured to receive a current geographical position attributed to the field device, and
wherein the electronic circuit-(174) is configured to compare the received current geographical position with a predefined geographical region and to control the near field communication unit-(176) to at least partially enable the near field communication in case the received current geographical position is within the predefined geographical region, or at least partially disable the near field communication in case the received current geographical position is outside the predefined geographical region.

5. The near field communication device according to claim 3, wherein the electronic circuit is configured to retrieve the predefined geographical region from a memory unit of the near field communication device or from a remote server, or wherein the electronic circuit is configured to receive the predefined geographical region from the field device.

6. The near field communication device according to claim 1, wherein the electronic circuit is configured to receive field device type data attributed to the field device and wherein the electronic circuit is configured to compare the received field device type data with a predefined list of field device types and to control the near field communication unit to at least partially enable the near field communication in case the field device type positively matches with at least one of the predefined field device types listed, or to at least partially disable the near field communication in case the determined field device type does not match with at least one of the predefined field device types listed.

7. The near field communication device according to claim 1, wherein the electronic circuit is configured to receive unique identification data information attributed to the field device, which uniquely identifies the field device and wherein the electronic circuit is configured to control the near field communication unit to enable the near field communication in case permissions of the near field communication device positively match with the unique identification data, or to disable the near field communication in case the permissions of the near field communication device do not match with the unique identification data.

8. A method of controlling a near field communication via a near field communication unit of a near field communication device with a field device of a heating, ventilation and air conditioning system, the method comprising:
receiving, by an electronic circuit of the near field communication device information attributed to the field device and/or retrieving, by the electronic circuit, information attributed to the near field communication device; and
controlling, by the electronic circuit, the near field communication unit connected to the electronic circuit, to at least partially enable or to at least partially disable the near field communication depending on at least one of: the received information or the retrieved information.

9. The method according to claim 8, wherein the information received comprises power supply data attributed to the field device indicating if the field device is currently supplied or not supplied with electrical energy, and
wherein the controlling comprises at least one of:
at least partially enabling, by the electronic circuit, the near field communication via the near field communication unit in case the received power supply data indicates that the field device is currently supplied with electrical energy; or
at least partially disabling, by the electronic circuit, the near field communication via the near field communication unit in case the received power supply data indicates that the field device is currently not supplied with electrical energy.

10. The method according to claim 8, wherein the retrieved information attributed to the near field communication device comprises geographical position data indicating a current geographical position of the near field communication device and
wherein the method further comprises:
comparing, by the electronic circuit, the current geographical position with a predefined geographical region; and
at least partially enabling, by the electronic circuit, the near field communication via the near field communication unit in case the current geographical position of the near field communication device is within the predefined geographical region; or
at least partially disabling by the electronic circuit, the near field communication via the near field communication unit in case the current geographical position of the near field communication device is outside the predefined geographical region.

11. The method according to claim 8, wherein the received information attributed to the field device comprises geographical position data indicating a current geographical position of the field device and
wherein the method further comprises:
comparing, by the electronic circuit, the current geographical position with a predefined geographical region; and
at least partially enabling, by the electronic circuit, the near field communication via the near field communication unit in case the current geographical position is within a predefined geographical region; or
at least partially disabling, by the electronic circuit, the near field communication via the near field communication unit in case the current geographical position is outside the predefined geographical region.

12. The method according to claim 10, further comprising:
retrieving, by the electronic circuit, the predefined geographical region from a memory unit of the near field communication device or a remote server, or
receiving, by the electronic circuit, the predefined geographical region from the field device

13. The method according to claim 8, wherein the information received, by the electronic circuit, from the field device comprises field device type data attributed to the field device, and
wherein the method comprises:
comparing, by the electronic circuit, the field device type data with a predefined list of field device types; and
at least partially enabling, by the electronic circuit, the near field communication via the near field communication unit in case the field device type data positively matches with at least one of the predefined field device types listed; or
at least partially disabling, by the electronic circuit, the near field communication via the near field communication unit in case the field device type data does not match with at least one of the predefined field device types listed.

14. The method according to claim 8, wherein the information received, by the electronic circuit, from the field device comprises unique identification data attributed to the field device which is configured to uniquely identify the field device and
wherein the controlling comprises at least one of:
at least partially enabling, by the electronic circuit the near field communication via the near field communication unit in case permissions of the near field communication device positively match with the unique identification data, or
at least partially disabling, by the electronic circuit, the near field communication via the near field communication unit in case the permissions of the near field communication device do not match with the unique identification data.

15. The method according to claim 8, further comprising:
providing, by the electronic circuit, a code and transmitting, via the near field communication unit, the code to the field device;
receiving, by the electronic circuit, information of a verification of the code from the field device; and
at least partially disabling, by the electronic circuit, the near field communication via the near field communication unit in case the verification information indicates a failed verification; or
at least partially enabling, by the electronic circuit, the near field communication via the near field communication unit in case the verification information indicates a successful verification.

16. A computer program product comprising computer program code configured to direct a near field communication device or an application running on the near field communication device such that the near field communication device or the application performs the method of claim 8.

17. A non-transitory computer-readable medium, having stored therein computer program code which, when executed by a near field communication device, causes the near field communication device to perform the method of claim 8.
